(19) United States
(12) Patent Application Publication
(10) Pub. No.: US 2021/0008475 A1
(43) Pub. Date: Jan. 14, 2021

(54) FILTER FOR GAS GENERATOR AND GAS GENERATOR

(71) Applicants: DAICEL CORPORATION, Osaka-shi, Osaka (JP); FUJI FILTER MANUFACTURING CO., LTD., Tokyo (JP)

(72) Inventors: Masato HIROOKA, Tokyo (JP); Mikio YABUTA, Tokyo (JP); Tsutomu OHIGASHI, Tokyo (JP); Takashi MATSUMOTO, Tokyo (JP); Kiyohisa KIKUCHI, Tokyo (JP)

(73) Assignees: DAICEL CORPORATION, Osaka-shi, Osaka (JP); FUJI FILTER MANUFACTURING CO., LTD., Tokyo (JP)

(21) Appl. No.: 16/980,630

(22) PCT Filed: Apr. 3, 2019
(86) PCT No.: PCT/JP2019/014749

§ 371 Date: Sep. 14, 2020

(30) Foreign Application Priority Data
Apr. 9, 2018 (JP) 2018-074863

(51) Int. Cl. B01D 39/10; B01D 39/20; B01D 46/24

(52) U.S. Cl. CPC B01D 39/10; B01D 39/2044; B01D 46/2403; B60R 21/26; B01D 2239/10; B01D 2239/1291; B01D 2279/10; B01D 2239/0613

(57) ABSTRACT

Provided is a cylindrical filter for a gas generator including a metal wire in a wound state, the metal wire including a plurality of recess portions provided on a first surface side and formed at intervals in a length direction thereof, the metal wire being wound with a surface including the recess portions facing an inner circumferential surface side of the cylindrical filter for a gas generator, and the recess portions of the metal wire being present on an inner side of the metal wire which extends from an inner circumferential surface toward an outer circumferential surface of the cylindrical filter.

### TECHNICAL FIELD

The present invention relates to a filter for a gas generator capable of being used in a gas generator for an airbag device installed in a vehicle and a gas generator using the same.

### BACKGROUND ART

In a gas generator that uses a gas generating agent as a gas generation source, a filter is used to filter out combustion residue from a combustion gas and to cool the combustion gas. Known filters include a cylindrical molded body with a metal wire wound around the molded body, a compression molded body of layered wire mesh, and the like.

The invention described in JP 2014-237389A is a filter for a gas generator and a gas generator using the same. The filter for a gas generator is a hollow cylindrical body including a wound body or a braided body of metal wire.

A hollow cylindrical filter 70A illustrated in FIGS. 1 and 2 is disposed inside a gas generator 1 with the filter 70A surrounding a combustion chamber 60. The combustion chamber 60 is filled with a gas generating agent 61, and the gas generating agent 61 starts combustion via flames from a transfer charge 56 ignited by an igniter 40.

The filter 70A described in JP 2014-237389A is formed by winding a wire 71 multiple times around a core forming layer, then removing the core and performing heat processing for sintering to weld the metal wire 71 together to form an integral body (see paragraphs [0084] to [0086]).

As illustrated in FIGS. 3 and 4, the wire 71 has a U-shaped cross-sectional shape and includes a groove portion 72 that continuously extends in a length direction. The groove portion 72 is formed facing the combustion chamber 60 side, and the residue in the combustion gas flowing from the combustion chamber 60 tends to catch in the groove portion 72.

### SUMMARY OF INVENTION

A first aspect of the present invention (hereinafter, referred to as the “first aspect”) provides a cylindrical filter for a gas generator, including:

a metal wire in a wound state, the metal wire including a plurality of recess portions provided on a first surface side and formed at intervals in a length direction thereof,

the metal wire being wound with a surface including the recess portions facing an inner circumferential surface side of the cylindrical filter for a gas generator, and

the recess portions of the metal wire being present on an inner side of the metal wire which extends from an inner circumferential surface toward an outer circumferential surface of the cylindrical filter.

Furthermore, the present invention provides a method of manufacturing the cylindrical filter for a gas generator, such as the method of manufacturing according to the first and second embodiment described below, that includes winding the metal wire with the surface of the metal wire including the recess portion facing an inner side of the cylindrical filter for a gas generator.

A second aspect of the present invention (hereinafter, referred to as the “second aspect”) provides a filter for a gas generator, including:

an assembly unit, the assembly unit including a combination of:

a first metal wire group including a plurality of first metal wires provided with a plurality of recess portions formed on a first surface side and at intervals in a length direction thereof, and

a second metal wire group including a plurality of second metal wires provided with a plurality of recess portions formed on a first side surface and at intervals in a length direction thereof,

the combination of the first metal wire group and the second metal wire group including,

the first metal wire group disposed side by side one another at intervals with the surfaces of the plurality of first metal wires including the recess portions facing up, and

the second metal wire group disposed on the first metal wire group side by side one another at intervals in a direction that intersects the first metal wire group, with the recess portions of the first metal wire group and the recess portions of the second metal wire group exposed;

in the assembly unit, the exposed recess portions of the assembly unit facing an identical direction, and

the filter for a gas generator having a columnar shape or a cylindrical shape.

A third aspect of the present invention (hereinafter, referred to as the “third aspect”) provides a filter for a gas generator, including:

an assembly unit, the assembly unit including a combination of:

a first metal wire group including a plurality of first metal wires provided with a plurality of recess portions formed on a first surface side and at intervals in a length direction thereof, and

a second metal wire group including a plurality of second metal wires provided with a plurality of recess portions formed on a first side surface and at intervals in a length direction thereof,

in the combination of the first metal wire group and the second metal wire group, the plurality of first metal wires and the plurality of second metal wires being woven together with the surfaces including the recess portions facing up, the plurality of first metal wires and the plurality of second metal wires intersecting one another, and the recess portions of the first metal wire group and the recess portions of the second metal wire group being exposed,

in a multilayer structure including a plurality of the assembly units, the exposed recess portions of the assembly units facing an identical direction; and

the filter for a gas generator having a columnar shape or a cylindrical shape.

Furthermore, the present invention also provides a method of manufacturing a columnar-shaped or cylindrical-shaped filter for a gas generator, such as the method of manufacturing according to the third and fourth embodiment described below.

Furthermore, the present invention provides a gas generator using the filter for a gas generator of the present invention.

### BRIEF DESCRIPTION OF DRAWINGS

The present invention will be more fully understood from the detailed description given herein below and the accompanying drawings, which are given for explanation only and do not limit the present invention.

FIG. 1 is a cross-sectional view in an axial direction of a gas generator including a filter for a gas generator of the present invention and a perspective view of the filter for a gas generator.

FIG. 2 is a plan view of a metal wire used in manufacturing a filter for a gas generator of the present invention with the surface including recess portions facing up.

FIG. 3 is a cross-sectional view taken along of FIG. 2.

FIGS. 4(a) to 4(d) are cross-sectional views taken along IV-IV of FIG. 2 of metal wires with a rectangular cross-sectional shape in the width direction including recess portions with different shapes. FIGS. 4(e) to 4(h) are cross-sectional views taken along IV-IV of FIG. 2 of metal wires with a circular cross-sectional shape in the width direction including recess portions with different shapes.

FIG. 5(a) is a perspective view of a portion of a metal wire of another embodiment. FIG. 5(b) is a perspective view of a portion of a metal wire of yet another embodiment.

FIG. 6(a) is an explanatory diagram of a method of manufacturing a metal wire used in manufacturing a filter for a gas generator of the present invention. FIG. 6(b) is a perspective view of a portion of a metal wire obtained by the method of manufacturing illustrated in FIG. 6(a). FIG. 6(c) is a perspective view of a portion of a metal wire of another embodiment obtained by the method of manufacturing illustrated in FIG. 6(a).

FIG. 7 is a cross-sectional view in an axial direction of a gas generator including a filter for a gas generator of another embodiment of the present invention and a perspective view of the filter for a gas generator.

FIG. 8 is an explanatory diagram of a method of manufacturing the filter for a gas generator illustrated in FIG. 7.

FIG. 9 is an explanatory diagram of a method of manufacturing the filter for a gas generator illustrated in FIG. 7, and an explanatory diagrams of a step after the state illustrated in FIG. 8.

FIG. 10 is an explanatory diagram of a method of manufacturing the filter for a gas generator illustrated in FIG. 7 of another embodiment.

### DESCRIPTION OF EMBODIMENTS

In JP2014-237389A, the cross-sectional shape of the wire is U-shaped as described above. Thus, when the wire 71 is wound around the core, there is less contact area between the wires 71 adjacent in the thickness direction. This may cause the increase in the overall strength of the filter after sintering to be insufficient.

The present invention provides a filter for a gas generator with a high capturing effect of high combustion residue in combustion gas, a high cooling effect of combustion gas, and maintained overall rigidity of the filter, and a gas generator using the same.

The filter for a gas generator of a first aspect is cylindrical and is formed by a metal wire being wound. All or a portion of the parts of the metal wire that come into contact with each other are joined together. To maintain the rigidity of the filter for a gas generator, all or most of the parts of the metal wire that come into contact with each other are preferably joined. However, a portion between the inner surface and the outer surface may not be joined, as long as sufficient rigidity is maintained to ensure the normal function as a filter for a gas generator.

The metal wire is preferably made of iron, copper plated iron, or the like.

A cross-sectional shape of the metal wire in a width direction thereof is not particularly limited and may be a circle, an ellipse, a rectangle, a rectangle with four rounded corners, a square, a square with four rounded corners, and the like.

The metal wire includes a plurality of recess portions at intervals in the length direction on one surface side.

In the case in which the cross-sectional shape of the metal wire in the width direction is a circle or an ellipse, one surface side is a portion corresponding to ½ of the circumference. The center (area center) of the recess portion may be located at a middle position of the ½ circumference or may be located to one side.

In the case in which the cross-sectional shape of the metal wire in the width direction is a rectangle (a rectangle or a square), one surface side is a surface of one of the long sides. The center of the recess portion may be located at a middle position in the width direction or may be located towards one side.

The recess portion is formed on a flat surface or curved surface of one surface (a surface including the recess portion) and is only required to be a portion that is deeper than the flat surface or the curved surface. The shape of the recess portion is not particularly limited and may be any desired shaped, such as a circle, an ellipse, a square, a rectangle, or an irregular shape. The depth of the recess portion is preferably ½ the thickness of the metal wire or less and more preferably ⅓ or less for the perspective of maintaining the strength of the metal wire.

The interval between the recess portions is not particularly limited. In the case in which the shape of the recess portion is a circle with a diameter (D), the interval between adjacent recess portions is preferably 2D or greater from the perspective of maintaining the strength of the metal wire.

Additionally, the recess portions are formed at intervals in the length direction on one surface of the metal wire, and the area of the recess portions is significantly less than the area of the groove portions in JP 2014-237389A. Thus, sufficient contact area between portions of the metal wire without the recess portion can be ensured. Thus, the overall rigidity of the filter is maintained at a sufficient level to function when used in the gas generator.

The intervals in the length direction of the recess portions of the metal wire may be even or uneven. In the case in which the intervals in the length direction of the recess portions is uneven, the length of the portion where the no recess portion is formed is not particularly limited, and length region portions where a recess portion is formed and length region portions where a recess portion is not formed may be present together.

The cylindrical filter for a gas generator is formed by the metal wire being wound with the surface including the recess portions facing radially inward. Thus, the recess portions are present only until reaching the inner circumferential surface of the metal wire, which extends from the inner circumferential surface toward the outer circumferential surface.

In the cylindrical filter for a gas generator, the recess portions can be made to be present at even intervals in a range that reaches the inner circumferential surface of the metal wire, which extends from the inner circumferential surface toward the outer circumferential surface. However, by adjusting the length of the region portions of the metal wire where no recess portions are formed, one or a plurality of thickness range portions, which are portions where no recess portions are present, of the inner surface of the metal wire, which extends from the inner circumferential surface toward the outer circumferential surface of the cylindrical filter, may be present.

For example, if the thickness of the cylindrical filter from the inner circumferential surface (0) to the outer circumferential surface (100) is defined as 100 (100%), then the recess portions can be made to not be present in a thickness range from 10 to 12% of the distance from the inner circumferential surface, a thickness range from 40 to 42%, and a thickness range from 70 to 72%. The width of the thickness range without the recess portions, the position of the thickness range without the recess portions, and the number of thickness ranges without the recess portions can be adjusted as appropriate.

In an embodiment in which such a thickness range portion without the recess portion is formed, the contact area between the wire increases, increasing the bonding strength. Thus, the overall strength of the cylindrical filter can be increased.

The filter for a gas generator of the first aspect is formed with the recess portions of the metal wire facing the inner circumferential surface side.

When the filter for a gas generator of the first aspect is used in the gas generator, the inside of the filter for a gas generator corresponds to a combustion chamber that is filled with a gas generating agent. Thus, the combustion gas flows from the inner circumferential surface of the filter for a gas generator toward the outer circumferential surface. At this time, the combustion residue contained in the combustion gas is filtered through the entire filter. Because the metal wire includes the recess portions, in this process, the combustion residue is more likely to be captured. This increases the effect of capturing the combustion residue.

Furthermore, the surface area of the metal wire including the recess portions is greater than that of a metal wire without recess portions. Thus, the contact area with the combustion gas is increased, and the cooling effect is increased.

In a preferred aspect (Aspect 1-1) of the filter for a gas generator of the first aspect, in the case in which the cross-sectional shape in the width direction of the metal wire is a rectangle, the recess portions are each formed as a groove extending between the two side surfaces opposite one another in the width direction. In the case in which the cross-sectional shape in the width direction of the metal wire is a circle or an ellipse, the recess portions are formed in a surface ⅓ or less of the circumference of the metal wire.

When the metal wire of Aspect 1-1 is used when the metal wire is wound around the core rod to form the filter, the recess portions with the shape described above action to not let the strain release when winding the metal wire. This makes the winding operation easy and is thus preferable.

In a preferred aspect (Aspect 1-2) of the filter for a gas generator of the first aspect, an occupancy area (a1) of the recess portions is 50% or greater of an area of the inner circumferential surface of the cylindrical filter for a gas generator.

When the filter for a gas generator of Aspect 1-2 is used in a gas generator, the combustion gas first passes through the inner circumferential surface of the cylindrical filter for a gas generator. Thus, because the occupancy area of the recess portions on the inner circumferential surface is great, the effect of capturing combustion residue contained in the combustion gas is further increased, which is preferable.

In a preferred aspect (Aspect 1-3) of the filter for a gas generator of the first aspect, an occupancy area (a2) of the recess portions is 50% or greater of an area of the metal wire on the inner circumferential surface side within a thickness range from the inner circumferential surface to a position ½t or less, where t is a thickness of the cylindrical filter for a gas generator, which is a distance from the inner circumferential surface to the outer circumferential surface; and an occupancy area (a3) of the recess portions is 50% or less of an area of the metal wire on the inner circumferential surface side within a thickness range from the position ½t from the inner circumferential surface to the outer circumferential surface.

The occupancy area of the recess portions from the inner circumferential surface of the cylindrical filter for a gas generator (cylindrical filter) to a ½t thickness (inner half) is greater than the occupancy area of the recess portions from the ½t thickness to the outer circumferential surface (outer half).

When the cylindrical filter of Aspect 1-3 is used in a gas generator, the combustion gas passes through the cylindrical filter from the inner circumferential surface to the outer circumferential surface. Thus, by using the cylindrical filter of Aspect 1-3, the effect of capturing the combustion residue contained in the combustion gas in the inner half of the cylindrical filter is increased, and because the contact area between metal wire in the outer half is increased, the rigidity of the cylindrical filter is increased, which are preferable.

The present invention provides a method of manufacturing (method of manufacturing of the first embodiment) the cylindrical filter for a gas generator according to the first aspect of Aspect 1-1, the method including:

winding the metal wire around a metal core rod; and

sintering and bonding together all or a portion of contact portions of the wound metal wire, wherein

the metal wire includes the plurality of recess portions provided on the first surface side and formed at intervals in the length direction thereof; and

in winding the metal wire, the metal wire is wound with the surface including the recess portions facing the inner side of the cylindrical filter.

The method of manufacturing of the first embodiment according to the invention is the same as the method of manufacturing a cylindrical filter (see, for example, paragraphs [0084], [0085], and [0086]) of the invention described in JP2014-237389A, except that the metal wire used includes a plurality of recess portions provided on the first surface side and formed at intervals in the length direction. However, compared to the cylindrical filter of the invention described in JP2014-237389A, the contact area between the metal wire is increased and the rigidity produced by bonding together the contact portions of the metal wire is increased, which are preferable.

The present invention provides a method of manufacturing (a method of manufacturing of the second embodiment) the cylindrical filter for a gas generator according to Aspect 1-2 or Aspect 1-3, the method including:

winding the metal wire around a metal core rod; and

sintering and bonding together all or a portion of contact portions of the wound metal wire, wherein

the metal wire includes the plurality of recess portions provided on the first surface side and formed at intervals in the length direction thereof, and the intervals between the recess portions increase in width from a first end portion corresponding to an initial winding portion toward a second end portion corresponding to a last winding portion; and

in winding the metal wire, the metal wire is wound with the surface including the recess portions facing the inner side of the cylindrical filter.

The method of manufacturing of the second embodiment according to the invention is the same as the method of manufacturing a cylindrical filter (see, for example, paragraphs [0084], [0085], and [0086]) of the invention described in JP2014-237389A, except that the intervals between the recess portions are not constant. However, compared to the cylindrical filter of the invention described in JP2014-237389A, the contact area between the metal wire is increased and the rigidity produced by bonding together the contact portions of the metal wire is increased, which are preferable. In particular, the rigidity in the outer half thickness range of the cylindrical filter is increased, which is more preferable from the perspective of maintaining the overall shape of the cylindrical filter.

In the filter for a gas generator of the second aspect, in the combination of the first metal wire group and the second metal wire group, the first metal wire group and the second metal wire group are arranged intersecting one another at a right angle or at an incline. The intersection angle in the case of intersecting at an incline is not particularly limited and, for example, can range from 45 degrees to less than 90 degrees.

All or a portion of the contact portions of the first metal wire group and the second metal wire group that form the assembly unit are bonded.

In the filter for a gas generator of the second aspect, the recess portions of all of the metal wires (the first metal wire and the second metal wire) that form the filter face the same direction.

For example, in the case in which the filter for a gas generator of the second aspect has a cylindrical shape and the filter includes a first end surface, a second end surface on the opposite side, and a circumferential surface, all of the recess portions face in the first end surface side or the second end surface side. In the case in which all of the recess portions of the filter for a gas generator of the second aspect face the first end surface side, filter is disposed with the first end surface is located opposing the combustion gas flow from the combustion chamber. This is preferable as the effect of capturing the combustion residue contained in the combustion gas via the recess portions is increased.

The cylindrical or cylindrical filter for a gas generator of the third aspect is the same as the filter for a gas generator of the second aspect except that the first metal wire group and the second metal wire group are woven together.

The weaving method of the first metal wire group and the second metal wire group is not particularly limited and a known method of plain weaving, dutch weaving, or the like may be used.

In a cylindrical or cylindrical filter for a gas generator of a preferred aspect (hereinafter, referred to as Aspect 2-1 and Aspect 3-1) of the second aspect and the third aspect, in a case in which a cross-sectional shape in a width direction of the first metal wire and a cross-sectional shape in the width direction of the second metal wire are rectangles, the recess portions are each formed in the surface including the recess portion as grooves extending between both side surfaces linking the surface including the recess portions; and

in a case in which the cross-sectional shape in the width direction of the first metal wire and the cross-sectional shape in the width direction of the second metal wire is a circle or an ellipse, the recess portions are each formed spanning across a surface ⅓ or greater of a circumference of the first metal wire and the second metal wire.

Using the assembly unit of Aspect 2-1 and Aspect 3-1 is preferable as the cross-sectional shape of the filter is easier to set to a discretionary shape.

The present invention provides a filter for a gas generator (hereinafter, referred to as the “fourth aspect”) of the second aspect, the third aspect, Aspect 2-1, and Aspect 3-1, in which

a plurality of the assembly units are layered with assembly units adjacent in a vertical direction being offset from one another to form a multilayer structure; and

the recess portions of the first metal wire group and the recess portions of the second metal wire group of each assembly unit are adjusted to not be blocked by the first metal wire group or the second metal wire group of an adjacent assembly unit.

The recess portions of the first metal wire group and the second metal wire group that form the assembly unit are exposed, and when a plurality of the assembly units are layered, the recess portions of a lower assembly unit may be covered by an upper assembly unit.

In such a case, the number of recess portions exposed (area of recess portions) is reduced. Thus, the effect of capturing the combustion residue contained in the combustion gas via the recess portions is reduced. For this reason, the assembly units adjacent in the vertical direction are offset from one another. This is preferably as a reduction in the number of recess portions (area of recess portions) of each assembly unit exposed can be suppressed. In the case in which the cross-sectional shape is a circle, the offset direction is a circumferential direction other than the horizontal direction.

The present invention provides a method of manufacturing (method of manufacturing of the third embodiment) a columnar-shaped or cylindrical-shaped filter for a gas generator from the assembly unit of the filter for a gas generator according to the second aspect, the method including:

a first step of placing the second metal wire group on the first metal wire group, fixing together contact portions, and manufacturing the assembly unit;

a second step of layering a plurality of the assembly units, then fusing together all or a portion of the contact portions by sintering and obtaining a multilayer structure; and

a third step of cutting out the multilayer structure in a columnar shape or a cylindrical shape, wherein

in the first step,

in the first metal wire group and the second metal wire group, the metal wires including the recess portions on the first surface side formed at intervals in the length direction are disposed side by side at intervals with the recess portions exposed;

when the second metal wire group is placed on the first metal wire group, the second metal wire group is placed in a direction intersecting the length direction of the first metal wire group, on the surface of the first metal wire group including the recess portions, with a surface of the second metal wire group without the recess portions being placed on a portion without the recess portions of the first metal wire group; and

the contact portions of the first metal wire group and the second metal wire group are fixed together by bonding together the contact portions via sintering or, in a case in which the first metal wire group or the second metal wire group use metal plating, melting and fusing together plate metal.

To sinter the multilayer structure of the assembly units in the second step, in the first step, the contact portions of the first metal wire group and the second metal wire group forming the assembly unit are bonded by sintering. Alternatively, the first metal wire group or the second metal wire group may use metal plating and this plate metal may be melted and fused together.

The present invention provides a method of manufacturing (a method of manufacturing of the fourth embodiment) a columnar-shaped or cylindrical-shaped filter for a gas generator from the assembly unit of the filter for a gas generator according to the third aspect, the method including:

a first step of weaving together the first metal wire group and the second metal wire group and manufacturing the assembly unit;

a second step of layering a plurality of the assembly units, then fusing together all or a portion of the contact portions by sintering and obtaining a multilayer structure; and

a third step of cutting out the multilayer structure in a columnar shape or a cylindrical shape, wherein

in the first step,

the first metal wire of the first metal wire group and the second metal wire of the second metal wire group are woven together with the surfaces including the recess portions facing up, a surface of the second metal wire without the recess portions not covering the recess portions of the first metal wire, and a surface of the first metal wire without the recess portions not covering the recess portions of the second metal wire.

In the method of manufacturing of the fourth embodiment, the first metal wire group and the second metal wire group are woven together to form the assembly. This eliminates the need for the operation of fixing together the first metal wire group and the second metal wire group of a single assembly, as in the method of manufacturing according to the third embodiment.

In a preferable method of manufacturing a cylindrical or cylindrical filter for a gas generator according to the method of manufacturing of the third embodiment or the fourth embodiment, in the second step, by offsetting assembly units adjacent in the vertical direction, a surface of an upper first metal wire group without the recess portions is adjusted to be not located on the recess portions of the first metal wire group and the recess portions of the second metal wire group of a lower assembly unit.

All of the recess portions of the first metal wire group and the second metal wire group that form the assembly unit are exposed, and when a plurality of the assembly units are layered, the recess portions of a lower assembly unit may be covered by an upper assembly unit.

In such a case, the number of recess portions exposed (area of recess portions) is reduced. Thus, the effect of capturing the combustion residue contained in the combustion gas via the recess portions is reduced. For this reason, the assembly units adjacent in the vertical direction are offset from one another. This is preferably as a reduction in the number of recess portions (area of recess portions) of each assembly unit exposed can be suppressed. In the case in which the cross-sectional shape is a circle, the offset direction is a circumferential direction other than the horizontal direction.

In the filter for a gas generator of the present invention, all of the recess portions of the metal wires face the same direction. Thus, in the case in which the filter for a gas generator of the present invention is disposed in a gas generator, by the recess portions being disposed opposed to the combustion gas flow, the effect of capturing the combustion residue contained in the combustion gas and the effect of cooling the combustion gas is increased.

In the filter for a gas generator according to the present invention, the metal wire of the filter includes the recess portions on the surface that opposes the combustion gas flow. Thus, the effect of capturing the combustion residue contained in the combustion gas is increased. Also, the surface area is increased by the metal wire being provided with the recess portions. This increases the effect of cooling the combustion gas. Furthermore, since the contact area between the metal wires is sufficiently ensured, the rigidity of the entire filter for a gas generator is maintained.

The filter for a gas generator of the present invention can be used as the filter for a gas generator that uses a gas generating agent as a gas generation source, such as a gas generator used in an airbag device install in a vehicle.

### Embodiments of the Invention

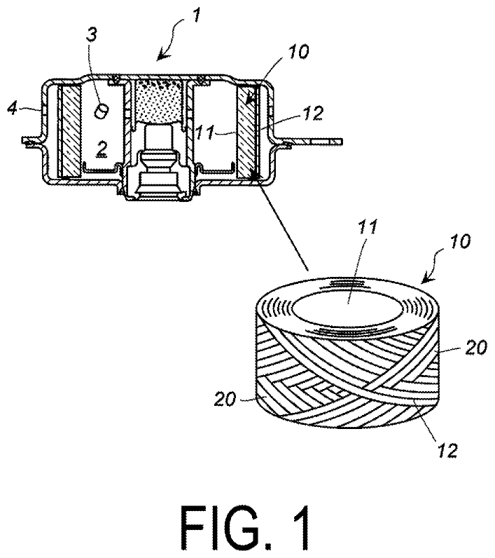

(1) Filter for a Gas Generator used in a Gas Generator illustrated in FIG. 1

A gas generator 1 illustrated in FIG. 1 includes a cylindrical filter for a gas generator (hereinafter referred to as a “cylindrical filter”) 10 of the present invention.

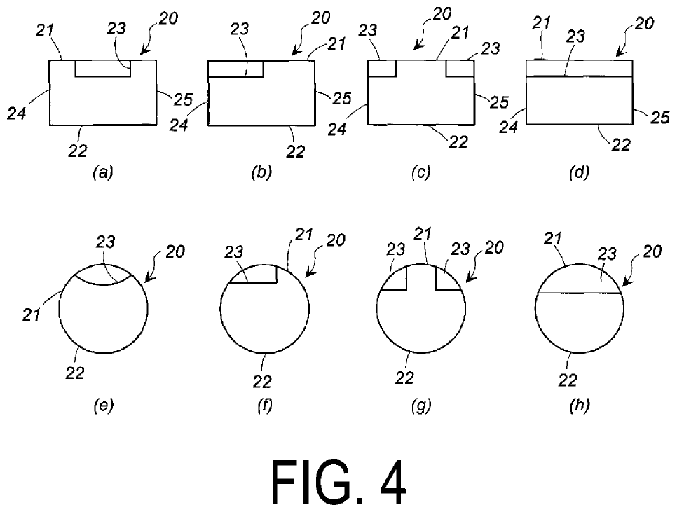

The gas generator 1 is, without the cylindrical filter 10, the same as a known gas generator (see FIG. 4 of JP 2005-193762), and the cylindrical filter 10 of the present invention can be used as a filter of the known disk-shaped gas generator illustrated in FIG. 1 using a gas generating agent as a gas generation source.

The cylindrical filter 10 includes an inner circumferential surface 11 and an outer circumferential surface 12. The inside of the cylindrical filter 10 (inner side of the inner circumferential surface 11) corresponds to a combustion chamber 2 where a gas generating agent 3 is housed. The outer circumferential surface 12 faces a gas discharge port 4. As illustrated in an enlarged view in FIG. 1, the cylindrical filter 10 is formed by winding a metal wire 20.

### Metal Wire

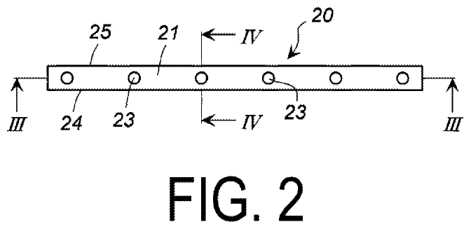

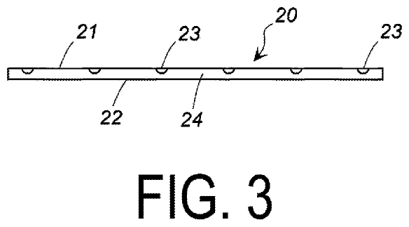

As illustrated in FIGS. 2 and 3, the metal wire 20 includes a first surface 21, a second surface 22 on the opposite side in the thickness direction to the first surface 21, a first side surface portion 24, and a second side surface portion 25.

The metal wire 20 includes a plurality of recess portions 23 formed at intervals in the length direction of the metal wire on the first surface 21. No recess portions are formed on the second surface 22 on the opposite side to the first surface 21, the first side surface portion 24, and the second side surface portion 25. In FIGS. 2 and 3, the plurality of recess portions 23 are formed at even intervals in the length direction. However, the intervals between the recess portions 23 may be irregular.

The cross-sectional shape of the metal wire 20 in the width direction is not particularly limited as long as the metal wire 20 can be wound, and for example, the cross-sectional shape may be a rectangle (or a rectangle with rounded corners) illustrated in FIGS. 4(a) to 4(d), a circle illustrated in FIGS. 4(e) to 4(h), a square, an ellipse, and the like.

In the case in which the metal wire 20 has the circular cross-section illustrated in FIGS. 4(e) to 4(h), the first surface 21 is the surface corresponding to a portion ½ of the circumference including the recess portions 23. The other portion corresponds to the second surface 22.

In some embodiments, the width of the recess portions 23 illustrated in FIGS. 4(a) to 4(h) is less than the width (diameter) of the metal wire 20. In other embodiments, the width of the recess portions 23 is the same as the width (diameter) of the metal wire 20.

In FIG. 4(a), the recess portion 23 is formed in a portion including a middle portion in the width direction of the metal wire 20 with a rectangular cross-sectional shape with rounded corners. The recess portion 23 is formed in the first surface 21. Note that the shape of the recess portion 23 may be a hemispherical shape such as that illustrated in FIG. 4(e) or any other shape. This is also the case for the embodiments illustrated in FIGS. 4(b) to 4(d) described below.

In FIG. 4(b), the recess portion 23 is formed from a middle portion in the width direction of the metal wire 20 with a rectangular cross-sectional shape with rounded corners to the first side surface portion 24.

In FIG. 4(c), the recess portion 23 is not formed in a portion including the middle portion in the width direction of the metal wire 20 with a rectangular cross-sectional shape with rounded corners, but formed at two sections on the first side surface portion 24 side and the second side surface portion 25 side.

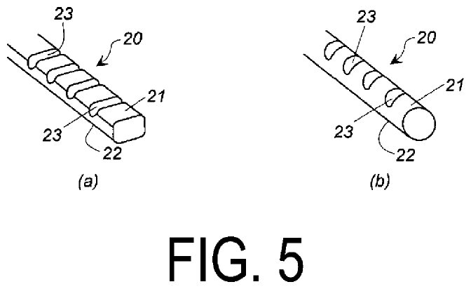

In FIG. 4(d), the recess portion 23 is formed as a groove from the first side surface portion 24 opposing the width direction of the metal wire 20 with a rectangular cross-sectional shape with rounded corners to the second side surface portion 25. This is also illustrated in a perspective view in FIG. 5(a).

In FIG. 4(e), the recess portion 23 is formed in a portion including a middle portion of the diameter of the metal wire 20 with a circular cross-sectional shape. The recess portion 23 is formed in the first surface 21. Note that the shape of the recess portion 23 may be a rectangular parallelepiped such as that illustrated in FIG. 4(a) or any other shape. This is also the case for the embodiments illustrated in FIGS. 4(f) to 4(h) described below.

In FIG. 4(f), the recess portion 23 is formed from or near to the middle portion of the diameter of the metal wire 20 with a circular cross-section to the outer circumferential surface.

In FIG. 4(g), the recess portion 23 is not formed in a portion including the middle portion of the diameter of the metal wire 20 with a circular cross-section, but formed at two sections at the outer circumferential surface on both sides.

In FIG. 4(h), the recess portion 23 is formed as a groove in a direction orthogonal to the length direction in a portion of the outer circumferential surface of the metal wire 20 with a circular cross-section. The recess portion 23 occupies a surface ⅓ or less of the circumference of the metal wire 20. FIG. 4(h) is illustrated in a perspective view in FIG. 5(b).

The depth (in cases in which the depth varies, the depth of the deepest portion) of the recess portions 23 illustrated in FIGS. 4(a) to 4(h) is adjusted to a range of from ½ to ¼ of the thickness (diameter) of the metal wire 20. This is to maintain the strength of the metal wire 20.

The shape of the recess portion 23 in a plan view is not particularly limited and can be a circle or a similar shape, a quadrangle or a similar shape, and the like.

In the case in which the shape of the recess portion 23 in a plan view is a circle with a diameter (D), the interval between adjacent recess portions 23 is preferably adjusted to 2D or greater from the perspective of maintaining the strength of the metal wire 20. The intervals between the recess portions 23 may not be even and may be formed at smaller intervals or longer intervals depending on the position in the length direction of the first surface 21 of the metal wire 20, for example.

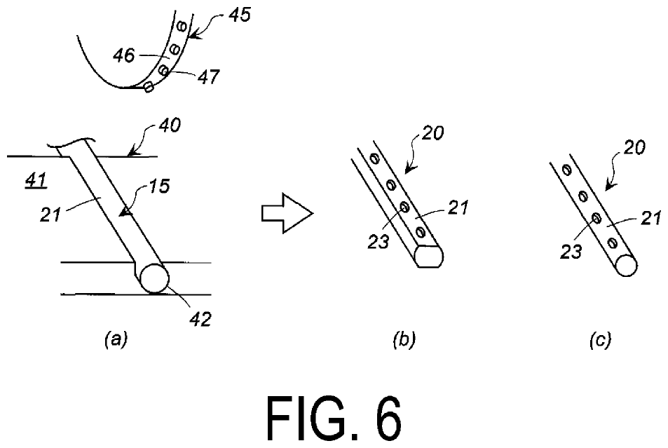

A method of manufacturing the metal wire 20 including the recess portions 23 illustrated in FIGS. 2, 3, 4(a), and 4(e) will be described with reference to FIGS. 6(a) to 6(c).

The metal wire 20 including the recess portions 23 can be manufactured with a combination of a molding die 40 and a molding roller 45.

The molding die 40 includes a molding groove 42 in a surface 41. A metal wire (metal wire precursor) 15 without the recess portions 23 is fit and secured in the molding groove 42. The metal wire precursor 15 is given a cross-sectional shape corresponding to the cross-sectional shape in the width direction of the molding groove 42 by being fitted into the molding groove 42.

The molding roller 45 has a circular plate shape, and a plurality of protrusion portions 47 are formed on a circumferential surface 46 at intervals in the circumferential direction.

The method of forming the recess portions 23 is as follows.

The molding roller 45 is rotated and the protrusion portions 47 on the circumferential surface 46 are continuously pressed into the first surface 21 of the metal wire precursor 15 fixed in the molding groove 42 of the molding die 40. In this way, the plurality of recess portions 23 are continuously formed at predetermined intervals (the intervals of the protrusion portions 47). In addition, by pressing the molding roller 45 into the metal wire precursor 15, the metal wire can be formed into a shape with a cross-sectional shape corresponding to that of the molding groove 42.

In this way, the metal wire 20 such as that illustrated in FIGS. 6(b) and 6(c) can be manufactured.

The metal wire 20 illustrated in FIGS. 4(b) to 4(d) and FIGS. 4(f) to 4(h) can be manufactured by using a molding roller including protrusion portions corresponding to the shape of the recess portions 23, instead of using the molding roller 45 illustrated in FIG. 6(a).

### Cylindrical Filter 10

The cylindrical filter 10 illustrated in FIG.1 is formed by the metal wire 20 being wound with the first surface 21 including the recess portions 23 illustrated in FIGS. 2 to 4 on the inner circumferential surface 11 side of the cylindrical filter 10.

The recess portions 23 of the metal wire 20 are present on the inner side of the metal wire 20, which extends from the inner circumferential surface 11 toward the outer circumferential surface 12 of the cylindrical filter 10.

Either all or a portion of the contact portions where the metal wire 20 comes into contact with itself are bonded by sintering to give the cylindrical filter 10 strength.

The occupancy area (a1) of the recess portions 23 can be 50% of or greater than the area of the inner circumferential surface 11. An occupancy area of the recess portions 23 at the inner circumferential surface 11 is preferably 50% or greater because, when the cylindrical filter 10 is used in the gas generator 1 illustrated in FIG. 1, the combustion residue contained in the combustion gas is more likely to be captured in the recess portions 23 when the combustion gas generated at the combustion chamber 2 passes from the inner circumferential surface 11 of the cylindrical filter 10 to the outer circumferential surface 12 and is discharged from the gas discharge port 4.

An occupancy area (a2) of the recess portions 23 can be 50% of or greater than the area of the first surface 21 of the wire 20 on the inner circumferential surface 11 side within a thickness range (thickness range of the inner half) from the inner circumferential surface 11 to ½t or less, where t is the thickness of the cylindrical filter 10 (the distance from the inner circumferential surface 11 to the outer circumferential surface 12), and an occupancy area (a3) of the recess portions 23 can be less than 50% of the area of the first surface 21 of the wire 20 on the inner circumferential surface 11 side within a thickness range (thickness range of the outer half) from a ½t thickness position from the inner circumferential surface 11 to the outer circumferential surface 12.

An occupancy area of the recess portions 23 in the inner half thickness range is preferably 50% or greater because, when the cylindrical filter 10 is used in the gas generator 1 illustrated in FIG. 1, the combustion residue contained in the combustion gas is more likely to be captured in the recess portions 23 when the combustion gas generated at the combustion chamber 2 passes from the inner circumferential surface 11 of the cylindrical filter 10 to the outer circumferential surface 12 and is discharged from the gas discharge port 4.

By making the occupancy area of the recess portions 23 in the outer half thickness range less than 50%, the area of each contact portion where the metal wire 20 comes into contact with itself in the thickness direction is increased. Thus, by bonding the contact portions, the rigidity in the outer half thickness range of the cylindrical filter 10 is increased, which is more preferable from the perspective of maintaining the overall shape and strength of the cylindrical filter 10.

### (2) Method of Manufacturing the Cylindrical Filter 10 Illustrated in FIG. 1

In a first step, the metal wire 20 is wound around the metal core rod with the first surface 21 of the recess portions 23 on the inner side (the side facing the core rod). By winding in this manner, all of the recess portions 23 of the metal wire 20 are present facing the inner circumferential surface 11 side of the cylindrical filter 10.

In a second step, the core rod is removed from the metal wire 20 wound around the metal core rod in the first step, and then the metal wire 20 is sintered and all or a portion of the contact portions of the wound metal wire 20 are bonded together and formed integrally. Then, the cylindrical filter 10 illustrated in FIG. 1 is obtained.

As described above, in the case in which, in the cylindrical filter 10, the occupancy area of the recess portions 23 differs in the inner half thickness range and the outer half thickness range, in the first step described above, the metal wire 20 such as that described below is used.

As the metal wire 20, a metal wire is used that has an interval in the length direction between recess portions 23 that increases in width from a first end portion, i.e., initial winding portion, toward a second end portion, i.e., last winding portion. Because the outer diameter of the cylindrical filter increases as the metal wire is wound around the core rod, the contact interval between radially adjacent metal wires changes. The intervals between the recess portions 23 is adjusted taking this into consideration.

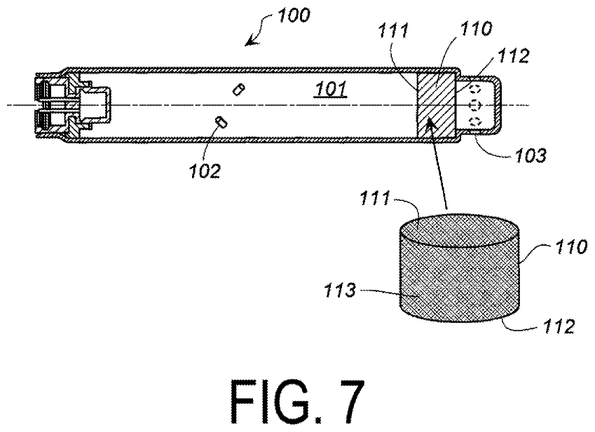

### (3) Filter for a Gas Generator Illustrated in FIG. 7

A gas generator 100 illustrated in FIG. 7 is, without the cylindrical filter 110 for a gas generator (hereinafter, referred to as the “cylindrical filter”) according to the present invention, the same as a known gas generator (see FIG. 1 of WO2015/025643A). The cylindrical filter 110 of the present invention can be used as a filter of a known cylindrical gas generator, such as that illustrated in FIG. 7, that uses a gas generating agent as a gas generation source.

The cylindrical filter 110 includes a first surface 111 facing a combustion chamber 101, a second surface 112 on the opposite side, and a circumferential surface 113.

The interior of the gas generator 100 is the combustion chamber 101 in which a gas generating agent 102 is housed.

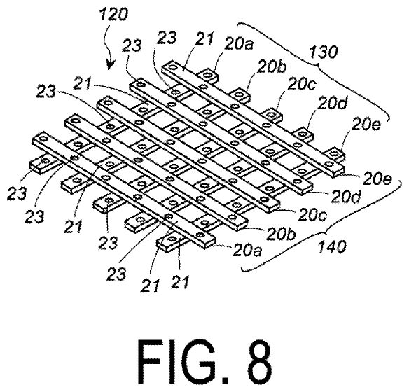

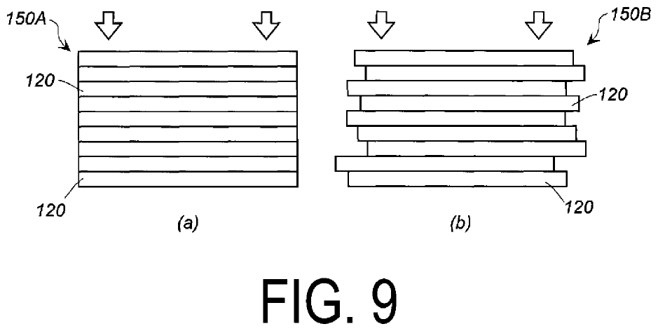

As illustrated in FIGS. 8 and 9, the cylindrical filter 110 illustrated in FIG. 7 is a sintered body of a multilayer structure 150A, 150B including layers of an assembly unit 120, the sintered body being cut into a cylindrical shape.

The assembly units 120 are each constituted by a combination of a first metal wire group 130 and a second metal wire group 140.

The metal wires 20 (20a to 20e), which include the recess portions 23 illustrated in FIGS. 2 and 3, of the first metal wire group 130 are disposed side by side at intervals with the recess portions 23 exposed. In FIG. 8, five of the first metal wires 20 (20a to 20e) are disposed. However, this number is not particularly limited and, for example, may be from 5 to 20.

Second metal wires 20 (20a to 20e), which include the recess portions 23 illustrated in FIGS. 2 and. 3, of the second metal wire group 140 are disposed, above the first surface 21 including the recess portions 23 of the first metal wire group 130, side by side at intervals in a direction that intersects the first metal wire group 130 at a right angle. The recess portions 23 of the second metal wires 20 (20a to 20e) face the same direction as the recess portions 23 of the first metal wires 20 (20a to 20e).

The cross-sectional shape in the width direction of the metal wires 20 that form the first metal wire group 130 and the second metal wire group 140 may be as illustrated in FIGS. 4(a) to 4(h). However, the cross-sectional shape in the width direction is preferably a rectangle or a similar shape such as those illustrated in FIGS. 4(a) to 4(d). In the case in which a circular (or elliptical) cross-sectional shape in the width direction, such as those illustrated in FIGS. 4(e) to 4(h) is used, a cross-sectional shape in which a portion of the first surface 21 and the second surface 22 is worked to be a flat surface is preferably used.

In the assembly unit 120 illustrated in FIG. 8, the second metal wire group 140 is not present directly above the recess portions 23 of the first metal wire group 130, and the recess portions 23 of the first metal wire group 130 are exposed. Because all of the recess portions 23 of the second metal wire group 140 are exposed, all of the recess portions 23 of the assembly unit 120 are not covered by the metal wire 20 and are in an exposed state.

FIG. 9 is a side view of a multilayer structure 150A, 150B including layers of the assembly unit 120. The plurality of assembly units 120 are layered with the recess portions 23 all facing the same direction.

FIG. 9(a) illustrates the multilayer structure 150A with the plurality of assembly units 120 illustrated in FIG. 8 layered on top on one another. FIG. 9(b) illustrates the multilayer structure 150B with the assembly units 120 adjacent in the vertical direction layered at a position offset from one another.

By forming the multilayer structure 150B with the assembly units 120 adjacent in the vertical direction being offset from one another, the positions can be adjusted so that, as much as possible, on top of the recess portions 23 of the second metal wire group 140 of the assembly unit 120, the first metal wire group 130 of another assembly unit 120 is not disposed.

The cylindrical filter 110 is a filter in which the multilayer structure 150A, 150B illustrated in FIGS. 9(a) and 9(b) is sintered or the multilayer structure 150A, 150B is compressed and sintered and then cut out into a cylindrical shape.

The cylindrical filter 110 used in the gas generator of FIG. 7 may, instead of using the assembly unit 120 illustrated in FIG. 8 in a multilayer structure, may use the assembly unit 120 illustrated in FIG. 8 as is.

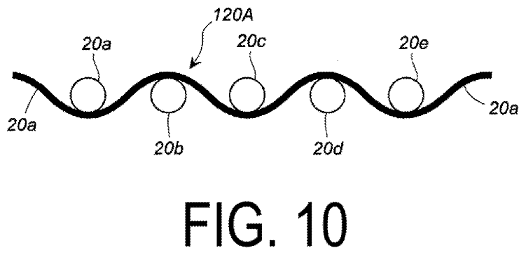

The cylindrical filter 110 illustrated in FIG. 7 can use the assembly unit 120A illustrated in FIG. 10 instead of the assembly unit 120 illustrated in FIG. 8.

The five first metal wires 20 (20a to 20e) and the five second metal wires 20 (20a to 20e) of the assembly unit 120A are arranged intersecting one another at a 90 degree angle as illustrated in FIG. 8. However, the first metal wire 20 (20a to 20e) and the five second metal wires 20 (20a to 20e) are woven together as illustrated in FIG. 10.

FIG. 10 illustrates, with reference to FIG. 8, how the five first metal wires 20 (20a to 20e) corresponding to the first metal wire group 130 and the first metal wire 20a of the second metal wire group 140 are woven together. Note that in FIG. 10, the woven state of the first metal wires 20 (20a to 20e) and the second metal wire 20 (20a to 20e) is illustrated for clarity, and the size relationship between the diameter of the first metal wires 20 (20a to 20e) and the diameter of the second metal wire 20 (20a to 20e) should be ignored.

In the assembly unit 120A Illustrated in FIG. 10, all of the recess portions 23 are exposed facing in the same direction.

### (4) Method of Manufacturing the Cylindrical Filter 110 Illustrated in FIG. 7

A method of manufacturing the cylindrical filter 110 illustrated in FIG. 7 will now be described.

In a first step, the second metal wire group 140 is placed on the first metal wire group 130, the contact portions are fixed, and the assembly unit 120 illustrated in FIG. 8 is manufactured.

When the second metal wire group 140 is placed on the first metal wire group 130, on the first surface 21 with the recess portions 23 of the first metal wire group 130, the second surface 22 without recess portions 23 of the second metal wire group 140 is placed on the portion of the first surface 21 without the recess portions 23. The second metal wire group 140 is placed orientated to intersect the length direction of the first metal wire group 130. The intersection angle illustrated in FIG. 8 is 90 degrees.

The contact portions of a multilayer structure unit 120 (the first metal wire group 130 and the second metal wire group 140) are bonded together by sintering. The bond at the contact portions of the assembly unit 120 should have the strength necessary for the layering in the next step.

In the case in which the assembly unit 120A illustrated in FIG. 10 is used instead of the assembly unit 120 illustrated in FIG. 8, the first metal wires 20a to 20e and the second metal wires 20a to 20e illustrated in FIG. 10 (only the second metal wire 20a is illustrated in FIG. 10) are woven together, and the assembly unit 120A is manufactured.

In the assembly unit 120A, since the first metal wire group 130 and the second metal wire group 140 are woven together, the first metal wire group 130 and the second metal wire group 140 do not need to be fixed together as in the assembly unit 120 illustrated in FIG. 8.

In a second step, after a plurality of the assembly units 120 (or assembly units 120A) are layered, all or a portion of the contact portions are fused by sintering, and the multilayer structure 150A illustrated in FIG. 9(a) is obtained.

Also, by offsetting the assembly units 120 adjacent to one another in the vertical direction as illustrated in FIG. 9(b), positions are adjust so that, on the recess portions 23 of the second metal wire group 140 of the lower assembly unit 120 (or assembly unit 120A), the surface of the upper first metal wire group 130 without the recess portions 23 is not located, and the multilayer structure 150B is obtained.

Thereafter, the multilayer structure 150A, 150B illustrated in FIGS. 9(a) and 9(b) is sintered, and all or a portion of the contact portions of the assembly unit 120 (or assembly unit 120A) are fused and bonded. Note that the multilayer structure 150A, 150B has high density, and thus can be compression molded before being sintered.

In a third step, the multilayer structure 150A, 150B obtained in step 2 is cut out into a cylindrical shape in the direction indicated by the white arrows, and the target filter 110 is manufactured. All of the recess portions 23 of the obtained cylindrical filter 110 face the first surface 111 side.

When the cylindrical filter 110 is disposed inside the gas generator 100 illustrated in FIG. 7, the combustion gas generated when the gas generating agent 102 inside the combustion chamber 101 combusts travels from the first surface 111 of the cylindrical filter 110 through the second surface 112 and is discharged from a gas discharge port 103. As a result, the combustion residue contained in the combustion gas is more likely to be captured by the recess portions 23 of the cylindrical filter 110. Note that the third step can be performed before the second step. In this case, the assembly unit illustrated in FIG. 8 or FIG. 10 is first cut into the desired shape, and then a plurality of these are layered and sintered to form the multilayer structure.

The present invention has been described as above. Of course, the present invention includes various forms of modifications within the scope thereof, and these modifications do not depart from the scope of the invention. All of what a person with ordinary skill in the art will clearly consider as a variation of the present invention is within the scope of the claims set forth below.

1-14. (canceled)

15. A cylindrical filter for a gas generator, comprising:
a metal wire in a wound state, the metal wire including a plurality of recess portions provided on a first surface side and formed at intervals in a length direction thereof,
the metal wire being wound with a surface including the recess portions facing an inner circumferential surface side of the cylindrical filter for a gas generator, and
the recess portions of the metal wire being present on an inner side of the metal wire which extends from an inner circumferential surface toward an outer circumferential surface of the cylindrical filter.

16. The cylindrical filter for a gas generator according to claim 15, wherein
in a case in which a cross-sectional shape in a width direction of the metal wire is a rectangle, the recess portions are each formed as a groove extending between two side surfaces opposite one another in the width direction; and
in a case in which the cross-sectional shape in the width direction of the metal wire is a circle or an ellipse, the recess portions are each formed as a surface ⅓ or less of a circumference of the metal wire.

17. The cylindrical filter for a gas generator according to claim 15, wherein an occupancy area (a1) of the recess portions is 50% or greater of an area of the inner circumferential surface of the cylindrical filter for a gas generator.

18. The cylindrical filter for a gas generator according to claim 15, wherein
an occupancy area (a2) of the recess portions is 50% or greater of an area of the metal wire on the inner circumferential surface side within a thickness range from the inner circumferential surface to a position ½t or less, where t is a thickness of the cylindrical filter for a gas generator, which is a distance from the inner circumferential surface to the outer circumferential surface; and
an occupancy area (a3) of the recess portions is 50% or less of an area of the metal wire on the inner circumferential surface side within a thickness range from the position ½t from the inner circumferential surface to the outer circumferential surface.

19. A method of manufacturing the cylindrical filter for a gas generator according to claim 15, comprising:
winding the metal wire around a metal core rod; and
sintering and bonding together all or a portion of contact portions of the wound metal wire, wherein
the metal wire includes the plurality of recess portions provided on the first surface side and formed at intervals in the length direction thereof; and
in winding the metal wire, the metal wire is wound with the surface including the recess portions facing the inner side of the cylindrical filter.

20. A method of manufacturing the cylindrical filter for a gas generator according to claim 16, comprising:
winding the metal wire around a metal core rod; and
sintering and bonding together all or a portion of contact portions of the wound metal wire, wherein
the metal wire includes the plurality of recess portions provided on the first surface side and formed at intervals in the length direction thereof; and
in winding the metal wire, the metal wire is wound with the surface including the recess portions facing the inner side of the cylindrical filter.

21. A method of manufacturing the cylindrical filter for a gas generator according to claim 17, comprising:
winding the metal wire around a metal core rod; and
sintering and bonding together all or a portion of contact portions of the wound metal wire, wherein
the metal wire includes the plurality of recess portions provided on the first surface side and formed at intervals in the length direction thereof, and the intervals between the recess portions increase in width from a first end portion corresponding to an initial winding portion toward a second end portion corresponding to a last winding portion; and
in winding the metal wire, the metal wire is wound with the surface including the recess portions facing the inner side of the cylindrical filter.

22. A filter for a gas generator, comprising:
an assembly unit, the assembly unit including a combination of:
a first metal wire group including a plurality of first metal wires provided with a plurality of recess portions formed on a first surface side and at intervals in a length direction thereof, and
a second metal wire group including a plurality of second metal wires provided with a plurality of recess portions formed on a first side surface and at intervals in a length direction thereof,
the combination of the first metal wire group and the second metal wire group including,
the first metal wire group disposed side by side one another at intervals with the surfaces of the plurality of first metal wires including the recess portions facing up, and
the second metal wire group disposed on the first metal wire group side by side one another at intervals in a direction that intersects the first metal wire group, with the recess portions of the first metal wire group and the recess portions of the second metal wire group exposed,
in the assembly unit, the exposed recess portions of the assembly unit facing an identical direction, and
the filter for a gas generator having a columnar shape or a cylindrical shape.

23. A filter for a gas generator, comprising:
an assembly unit, the assembly unit including a combination of:
a first metal wire group including a plurality of first metal wires provided with a plurality of recess portions formed on a first surface side and at intervals in a length direction thereof, and
a second metal wire group including a plurality of second metal wires provided with a plurality of recess portions formed on a first side surface and at intervals in a length direction thereof,
in the combination of the first metal wire group and the second metal wire group, the plurality of first metal wires and the plurality of second metal wires being woven together with the surfaces including the recess portions facing up, the plurality of first metal wires and the plurality of second metal wires intersecting one another, and the recess portions of the first metal wire group and the recess portions of the second metal wire group being exposed,
in a multilayer structure including a plurality of the assembly units, the exposed recess portions of the assembly units facing an identical direction, and
the filter for a gas generator having a columnar shape or a cylindrical shape.

24. A columnar-shaped or cylindrical-shaped filter for a gas generator according to claim 22, wherein
in a case in which a cross-sectional shape in a width direction of the first metal wire and a cross-sectional shape in the width direction of the second metal wire are rectangles, the recess portions are each formed in the surface including the recess portion as grooves extending between both side surfaces linking the surface including the recess portions; and
in a case in which the cross-sectional shape in the width direction of the first metal wire and the cross-sectional shape in the width direction of the second metal wire is a circle or an ellipse, the recess portions are each formed spanning across a surface ⅓ or less of a circumference of the first metal wire and the second metal wire.

25. A columnar-shaped or cylindrical-shaped filter for a gas generator according to claim 23, wherein
in a case in which a cross-sectional shape in a width direction of the first metal wire and a cross-sectional shape in the width direction of the second metal wire are rectangles, the recess portions are each formed in the surface including the recess portion as grooves extending between both side surfaces linking the surface including the recess portions; and
in a case in which the cross-sectional shape in the width direction of the first metal wire and the cross-sectional shape in the width direction of the second metal wire is a circle or an ellipse, the recess portions are each formed spanning across a surface ⅓ or greater of a circumference of the first metal wire and the second metal wire.

26. The filter for a gas generator according to claim 22, wherein
a plurality of the assembly units are layered with assembly units adjacent in a vertical direction being offset from one another to form a multilayer structure; and
the recess portions of the first metal wire group and the recess portions of the second metal wire group of each assembly unit are adjusted to not be blocked by the first metal wire group or the second metal wire group of an adjacent assembly unit.

27. The filter for a gas generator according to claim 23, wherein
a plurality of the assembly units are layered with assembly units adjacent in a vertical direction being offset from one another to form a multilayer structure; and
the recess portions of the first metal wire group and the recess portions of the second metal wire group of each assembly unit are adjusted to not be blocked by the first metal wire group or the second metal wire group of an adjacent assembly unit.

28. A method of manufacturing a columnar-shaped or cylindrical-shaped filter for a gas generator from the assembly unit of the filter for a gas generator according to claim 22, comprising:
a first step of placing the second metal wire group on the first metal wire group, fixing together contact portions, and manufacturing the assembly unit;
a second step of layering a plurality of the assembly units, then fusing together all or a portion of the contact portions by sintering and obtaining a multilayer structure; and
a third step of cutting out the multilayer structure in a columnar shape or a cylindrical shape, wherein
in the first step,
in the first metal wire group and the second metal wire group, the metal wires including the recess portions on the first surface side formed at intervals in the length direction are disposed side by side at intervals with the recess portions exposed;
when the second metal wire group is placed on the first metal wire group, the second metal wire group is placed in a direction intersecting the length direction of the first metal wire group, on the surface of the first metal wire group including the recess portions, with a surface of the second metal wire group without the recess portions being placed on a portion without the recess portions of the first metal wire group; and
the contact portions of the first metal wire group and the second metal wire group are fixed together by bonding together the contact portions via sintering or, in a case in which the first metal wire group or the second metal wire group use metal plating, melting and fusing together plate metal.

29. A method of manufacturing a columnar-shaped or cylindrical-shaped filter for a gas generator from the assembly unit of the filter for a gas generator according to claim 23, comprising:
a first step of weaving together the first metal wire group and the second metal wire group and manufacturing the assembly unit;
a second step of layering a plurality of the assembly units, then fusing together all or a portion of the contact portions by sintering and obtaining a multilayer structure; and
a third step of cutting out the multilayer structure in a columnar shape or a cylindrical shape, wherein
in the first step,
the first metal wire of the first metal wire group and the second metal wire of the second metal wire group are woven together with the surfaces including the recess portions facing up, a surface of the second metal wire without the recess portions not covering the recess portions of the first metal wire, and a surface of the first metal wire without the recess portions not covering the recess portions of the second metal wire.

30. The method of manufacturing a columnar-shaped or cylindrical-shaped filter for a gas generator according to claim 24, wherein
in the second step, by offsetting assembly units adjacent in the vertical direction, a surface of an upper first metal wire group without the recess portions is adjusted to be not located on the recess portions of the first metal wire group and the recess portions of the second metal wire group of a lower assembly unit.

31. The method of manufacturing a columnar-shaped or cylindrical-shaped filter for a gas generator according to claim 29, wherein
in the second step, by offsetting assembly units adjacent in the vertical direction, a surface of an upper first metal wire group without the recess portions is adjusted to be not located on the recess portions of the first metal wire group and the recess portions of the second metal wire group of a lower assembly unit.

32. A gas generator using the filter for a gas generator according to claim 15.

33. A gas generator using the filter for a gas generator according to claim 22.

34. A gas generator using the filter for a gas generator according to claim 23.
